(19) United States
(12) Patent Application Publication
(10) Pub. No.: US 2024/0239537 A1
(43) Pub. Date: Jul. 18, 2024

(54) APPARATUSES DEVICES AND METHODS FOR HARVESTING OR COLLECTING SEAWEED AND AQUATIC FLORA FROM LARGE BODIES OF WATER FOR STORING AND TRANSPORTING SEAWEED AND AQUATIC FLORA

(71) Applicant: CLIMATE FOUNDATION, Seattle, WA (US)

(72) Inventor: Brian von HERZEN, Carson City, NV (US)

(73) Assignee: CLIMATE FOUNDATION, Seattle, WA (US)

(21) Appl. No.: 18/562,817

(22) PCT Filed: May 20, 2022
(86) PCT No.: PCT/US22/30397

§ 371 Date: Nov. 20, 2023

Related U.S. Application Data
(60) Provisional application No. 63/191,433, filed on May 21, 2021.
(60) Provisional application No. 63/191,453, filed on May 21, 2021.

(51) Int. Cl. B65B 25/02; A01D 44/00; B65B 9/207; B65B 13/02; B65B 37/00; B65B 51/07; B65D 75/42; B65D 85/50

(52) U.S. Cl. CPC B65B 25/02; A01D 44/00; B65B 9/207; B65B 13/02; B65B 37/005; B65B 51/07; B65D 75/42; B65D 85/50

(57) ABSTRACT

Disclosed are a system and method for packaging seaweed and/or aquatic plants. The system includes a wrapping mechanism configured to wrap the seaweed or aquatic plants in a lightweight material, a sealer configured to seal the lightweight material with the seaweed or aquatic plants therein, and a unitizer or link former configured to form fastened units from the lightweight material with the seaweed or aquatic plants therein. The method includes placing or depositing the seaweed or the aquatic plant(s) on a sheet of a lightweight material, wrapping the seaweed or the aquatic plant(s) in the lightweight material, and sealing the lightweight material to form a packaged unit or link in which the seaweed or aquatic plant(s) is sealed or otherwise contained in the lightweight material.

### CROSS REFERENCE TO RELATED APPLICATIONS

This application claims the benefit of U.S. Provisional Patent Application Nos. 63/191,433 and 63/191,453, both of which were filed on May 21, 2021, and both of which are incorporated herein by reference as if fully set forth herein.

### FIELD OF THE INVENTION

The present invention generally relates to the field of harvesting or collecting seaweed, for example Sargassum spp., and aquatic flora such as aquatic plants from a large, and preferably natural, body of water.

### DISCUSSION OF THE BACKGROUND

An average of 10-40 dry megatons (10-40×10⁶ kg) of Sargassum grow wild annually in the last decade in the Atlantic Ocean and the Caribbean alone. Much of that seaweed is concentrated in the eponymous Sargasso Sea, as well as the Gulf of Mexico, the Atlantic Ocean around the Bahamas, and in the Pacific Ocean, just off the coast.

Sargassum has evolved to float and circulate through the gyres of the oceans, and it can accrue in very large quantities. Several species, including Sargassum fluitans, never need to secure themselves to the seafloor during their life cycle in order to reproduce and continue growing. These large quantities present a liability to the tourism industry and local environment but also a business opportunity for harvesting/collecting Sargassum and other seaweeds and a climactic opportunity for carbon sequestration.

Wild-grown Sargassum also presents interesting opportunities for the production of seaweed based biostimulants, hydrocolloid products as well as biofuels. The liquid portion of the Sargassum plant has been shown to provide a positive impact on plant growth similar to other seaweed-derived biostimulants. Additionally, the Sargassum husks remaining after removal of the liquid may be dried and utilized as biofuel (to produce biogas or ethanol, for example).

Sargassum has shown excellent resilience to the increases in ocean temperatures and acidity, with growth rates apparently increasing. As such, Sargassum is capable of removing carbon from the upper ocean and consequently the atmosphere, and transforming this carbon into cellulose. If the Sargassum were to be made to sink to the deep ocean, the carbon content of the sunk Sargassum may be considered sequestered for some time, depending on the depth to which it is sunk and exact location.

As Sargassum accumulates in large quantities and floats, it is prone to creating what is known as a “golden tide.” This golden tide has a tendency to wash ashore on beaches that are frequented by tourists. There it will slowly decompose anaerobically, releasing harmful gases such as sulfur dioxide (which is toxic at high levels) and methane, a greenhouse gas which is 21-71 times as potent as carbon dioxide, creating a foul stench and diminishing the tourism industry in that region. Rotting Sargassum also harms local marine life and ecosystems. There is significant commercial interest in the ability to predict the landing of a golden tide, and there is a need to avert golden tides by removing the Sargassum from the water before it washes ashore.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

For all of the reasons listed above, Sargassum and other seaweeds and aquatic plants represent a clear opportunity for the further development of non-disruptive and cost-effective harvesting and collecting. Significant effort has been put into developing harvesting and transportation technologies by the present Applicant(s). However, the transportation of 10 megatons or more of biomass over 500 miles of open ocean can be immensely expensive. This quantity of seaweed/plant material would require hundreds of trips with the largest of container vessels. This transportation would be enormously expensive from both capital expense and operational expense perspectives.

In some embodiments, the present system for harvesting or collecting seaweed and aquatic plants comprises a platform, a first conveyor configured to collect the seaweed or aquatic plant from a body of water and transport the seaweed or aquatic plant to the platform, and a second conveyor configured to transport the seaweed or aquatic plant from the platform to a deck or cargo hold of a vessel, such as a ship or boat. The body of water is preferably large and natural, and may be a lake, bay, inlet, river, gulf, sea, ocean, or the like.

The present invention also includes a method of harvesting seaweed and aquatic plants from a body of water, comprising collecting the seaweed or aquatic plant from the body of water and transporting the seaweed or aquatic plant to a platform using a first conveyor, and transporting the seaweed or aquatic plant from the platform to a deck or cargo hold of a vessel, such as a ship or boat, using a second conveyor.

In some embodiments, the present system for packaging seaweed and/or aquatic plants comprises a wrapping mechanism configured to wrap (e.g., bale) the seaweed or aquatic plants in an organic polymer or another watertight, lightweight material, a fastening and/or sealing mechanism configured to attach or secure the organic polymer or other material with the seaweed or aquatic plants therein, and a unitizer or link former configured to form a fastened or sealed unit (e.g., pods, casings, packets, parcels or links) from the organic polymer or other material with the seaweed or aquatic plants therein. The system for packaging seaweed and/or aquatic plants may further comprise one or more rollers, at least one of which has the organic polymer or other material in a roll thereon. The present system for packaging seaweed and/or aquatic plants may be installed on (and optionally at least partially below) the deck of a vessel, such as a ship or boat, which can process the seaweed and/or aquatic plants, and transport the packaged (and optionally processed) seaweed and/or aquatic plants (e.g., to shore or another destination at which the seaweed and/or aquatic plants are unloaded). The packaged seaweed/aquatic plant units or links may also be stored prior to and/or after being transported, and prior to or after processing the seaweed or aquatic plants.

The present system for packaging seaweed and/or aquatic plants may form packaged seaweed and/or aquatic plants in the form of a roll, and may comprise a linear system. The present packaging system may be combined with the present seaweed harvesting and/or collecting system and apparatus. Using light-weight and/or low-density, relatively strong materials such as polyethylene, nylon or a biodegradable, waterproof or water-repellant polymer such as thermoplastic polyurethanes (e.g., in the form of a large sheet or a roll, including an annular roll), the apparatus may comprise a material closing ramp and a compression ring. Optionally, the apparatus may further comprise a compression piston on a wheel or similar device to force the seaweed or aquatic plants through the compression ring. However, the amount of compression provided by gravity and the inherent compression of the stitching machine is oftentimes acceptable.

For the packaged seaweed/plants in roll form, in a segment-at-a-time configuration (e.g., as links) the apparatus may comprise the (linear) system described in the preceding paragraph, plus a clamping machine configured to create the joints or links between sections of the packaged seaweed/plants, a vacuum pump (e.g., configured to evacuate the links or sections of the packaging), a spool of metal (e.g., amsteel) cable to run through the interior of the packaged seaweed/plants (e.g., to enable towing the packaged seaweed/plants and/or reinforce the links or joints between sections of the packaged seaweed/plants). The link system may decrease the water content of the packaged seaweed/plants, making it less massive, and providing discrete units for transportation (e.g., after the packaged seaweed/plants is/are brought to shore).

The present invention also includes a method of packaging seaweed and aquatic plants, comprising placing or depositing the seaweed or aquatic plant(s) on a sheet of an organic polymer or other material, wrapping the seaweed or aquatic plant(s) in the organic polymer or other material, and fastening the organic polymer or other material (e.g., to itself) to form a packaged unit or link in which the seaweed or aquatic plant(s) is secured, sealed or otherwise contained in the organic polymer or other material. Sealing the organic polymer or other material may comprise stitching one or more edges of the sheet to an opposite edge or other part of the sheet, and compressing or stitching the organic polymer or other material cross-wise (e.g., in a region in which the seaweed or aquatic plant[s] is/are not present). The method may be repeated one or more times (e.g., hundreds of times) to form a series of linked packaged units of seaweed or aquatic plants.

The method may further comprise transporting the seaweed on a body of water, such as a large and natural body of water (e.g., a lake, bay, inlet, river, gulf, sea, ocean, or the like) using a vessel, such as a ship or boat. Alternatively, the method may comprise placing or depositing the seaweed or aquatic plant(s) in a sleeve or cylinder of the organic polymer or other material, in which case sealing the organic polymer or other material may comprise simply compressing or stitching the organic polymer or other material cross-wise to form the packaged unit(s) or link(s).

New equipment designed for the specific purpose of harvesting or collecting Sargassum and other seaweed and aquatic plants would require enormous capital expenditures, both for research and development (R&D) and for construction of new large vessels (e.g., ships or boats). However, the present invention is able to repurpose existing capital assets. Systems and methods have been developed to augment existing capital assets and provide an affordable and easily-scalable method of harvesting or collecting Sargassum and other seaweed and aquatic plants.

The resulting packaged seaweed/aquatic plant units are designed to float and/or to have low hydrodynamic drag. Thus, the packaged seaweed/aquatic plant units may be transported by a relatively small vessel. Alternatively, a single seaweed/aquatic plant harvesting/collecting and packaging vessel can be accompanied by multiple smaller packaged seaweed/aquatic plant unit transporting vessels.

A container ship filled to capacity with 20,000 twenty-foot equivalent units (TEUs) of Sargassum or other aquatic flora may hold approximately 130,000 metric tons of plant material. However, 50 full shiploads of harvested/collected Sargassum (no small feat to arrange and execute) would carry less than half of the smallest worldwide annual growth.

Sargassum tides are currently habitats for many marine species. Indiscriminate harvesting or collecting of wild Sargassum could result in an unacceptable disruption of the local marine life. As such, technologies should be developed to avoid such unacceptable disruption. This concern is not addressed in any system or method for harvesting or collecting seaweed known to the inventors. However, the present system, which does not use nets, cages, or walled equipment, allows fish and other marine animals to escape back into the water if inadvertently collected from the water.

These and other advantages of the present invention will become readily apparent from the detailed description of various embodiments below.

### BRIEF DESCRIPTION OF THE DRAWINGS

FIG. 1 shows a ship (not drawn to scale) deploying the present seaweed harvesting and/or collecting system.

FIG. 2 shows an exemplary conveyor for use in the present invention.

FIG. 3 shows the exemplary conveyor of FIG. 2 deployed in the water.

FIGS. 4A-B show the exemplary conveyor of FIG. 2 deployed (FIG. 4A) and stowed within the vessel (FIG. 4B) according to embodiments of the invention.

FIGS. 5A-B show an exemplary seaweed harvesting and/or collecting system deployed (FIG. 5A) and stowed within and alongside the vessel (FIG. 5B) according to embodiments of the invention.

FIG. 6A shows an exemplary conveyor configured to immerse the seaweed in the water after initial collection according to embodiments of the invention, and FIG. 6B shows an exemplary roller shield for the exemplary conveyor of FIG. 6A, configured to prevent the seaweed from being trapped between the rollers and the conveyor belt according to one or more embodiments of the invention.

FIG. 7 shows the ship and the seaweed and aquatic plant harvesting and/or collecting system of FIG. 1, in conjunction with an exemplary seaweed and aquatic plant packaging system in accordance with embodiments of the present invention.

FIG. 8 shows a cross-section of the exemplary seaweed/aquatic plant packaging system of FIG. 7.

FIG. 9 shows an alternative seaweed/aquatic plant packaging system according to embodiments of the invention.

FIG. 10A shows a perspective view of the exemplary seaweed/aquatic plant packaging system of FIGS. 7-8 on a ship or boat, and FIG. 10B shows a top view of the exemplary seaweed/aquatic plant packaging system of FIGS. 7-8 with an alternative seaweed and aquatic plant harvesting and/or collecting system according to embodiments of the invention.

FIG. 11 shows exemplary packaged seaweed links according to embodiments of the invention.

FIG. 12 shows a top view of an alternative seaweed and aquatic plant packaging system with the seaweed and aquatic plant harvesting and/or collecting system of FIG. 10B according to embodiments of the invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

The term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

### An Exemplary Harvesting and or Collecting System

The present harvesting and/or collecting system may comprise a simply-constructed conveyor system. For example, FIG. 1 shows an exemplary system 100 configured to harvest or collect seaweed 120 (or other floating sea flora), deployed on a boat or ship 110. The system 100 comprises a platform 140, a first conveyor 130 configured to collect the seaweed 120 from a body of water 105 and transport the seaweed 120 to the platform 140, and a second conveyor 150 configured to transport the seaweed 120 from the platform 140 to the cargo hold 115 of the ship or boat 110. The conveyors 130 and 150 and the platform 140 may be commercially available, or may be custom-made or optimized for a particular boat or ship 110 and/or for a particular type of seaweed or aquatic plant (e.g., Sargassum). In addition to Sargassum (e.g., Sargassum fusiforme), the exemplary harvesting and/or collecting system 100 can also be used to collect other seaweed, such as Eucheuma (e.g., Eucheuma cottonii or Eucheuma denticulatum, for production of carrageenan or food), Kappaphycus alvarezii, Gracilaria (particularly those species used for production of agar or ogonori), Saccharina (e.g., Saccharina latissima and Saccharina japonica), Undaria pinnatifida, Pyropia (particularly those species used for production of nori, Betaphycus gelatinae, Caulerpa lentillifera (e.g., for production of sea grapes), Chondrus crispus (Irish moss), and other kelp (e.g., of the orders Laminariales and Fucales, such as giant kelp [Macrocystis pyrifera] and giant brown kelp [Ecklonia maxima]), which along with certain Sargassum species, can be used as a food source, a source of raw material for value-added natural products, or a carbon sink for carbon credits (see, e.g., U.S. Provisional Pat. Appl. Nos. 63/191,798, and 63/191,505, both of which were filed on May 21, 2021 [Atty. Docket Nos. CF-014-PR and CF-016-PR], the relevant portions of each of which are incorporated herein by reference). Furthermore, the present harvesting and/or collecting system 100 can also be used to harvest or collect seaweed or other macroalgae/aquatic flora grown on/in a platform/system for growing macroalgae and aquatic plants (see, e.g., U.S. Provisional Pat. Appl. No. 63/191,798, filed on May 21, 2021 [Atty. Docket No. CF-014-PR], the relevant portions of which are incorporated herein by reference).

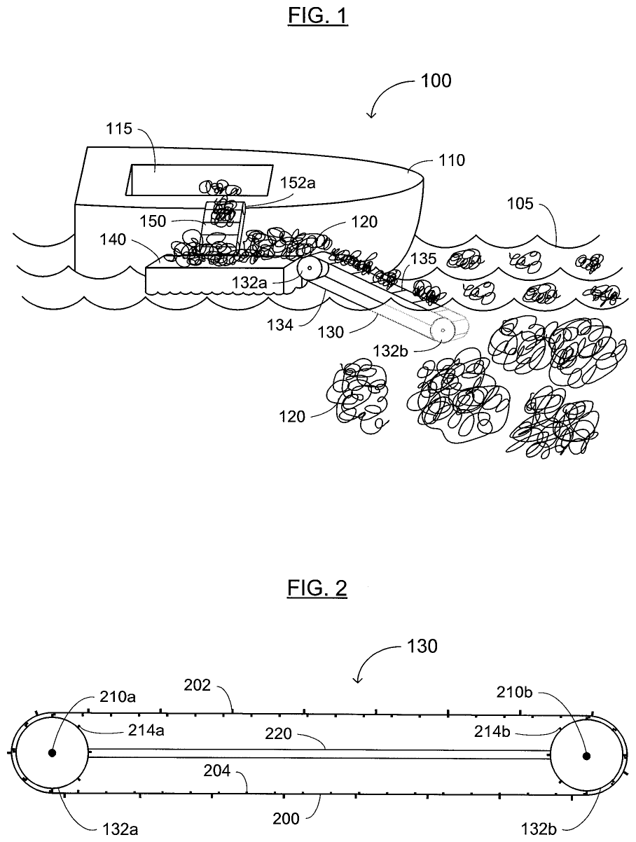

FIG. 2 shows the first conveyor 130 in greater detail. The first conveyor 130 comprises first and second rollers 132a-b and a belt 200 thereon. The first and second rollers 132a-b rotate around respective first and second axles 210a-b, and are fixed in positions relative to each other by a beam 220 mechanically secured to the axles 210a-b. The beam 220 may comprise steel (which may be coated with a water-repellant or -resistant coating), but the invention is not so limited. The second conveyor 150 (FIG. 1) also comprises a first roller 152a, a second roller (not shown) and a belt thereon. The second conveyor 150 is structurally and functionally similar or identical to the first conveyor 130.

The system 100 (i.e., the first conveyor 130 and the platform 140, placed end-to-end) may have a length that is 20-80% (e.g., approximately 50%, of any other length or range of lengths within the range of 20-80%) of the length of the vessel 110. The first and second conveyors 130 and 150 may each have a width of 1-5 meters or any width or range of widths therein.

The platform 140 may have a length and an independent width of from 120% to 500% of the width(s) of the first conveyor 130 and/or second conveyor 150, and an area of 10-100 square meters. The platform 140 may float on the water 105 or may be secured to the side of the boat or ship 110.

As shown more clearly in FIG. 3, the first conveyor 130 may be inclined at an angle of 10-40° (e.g., approximately 20° or any other angle or range of angles between 10° and) 40° with respect to the surface 107 of the water 105. One end of the first conveyor 130 (e.g., the end containing the roller 132b) may be 0.5-5 meters (e.g., about 1 meter or any other distance or range of distances between 0.5 and 5 meters) under the water surface 107, and the other end (e.g., the end containing the other roller 132a) may be a distance above the water enabling the seaweed 120 to be deposited onto the platform 140.

Referring to FIGS. 1-3, as the vessel 110 moves slowly through water 105 (e.g., the tide of Sargassum 120), the first conveyor 130 simply brings the seaweed 120 out of the water 105 using the bars or ridges 202. The bars or ridges 202 may have a height or width of 5-50 cm (or any value or range of values therein) and a length of 80-100% (or any value or range of values therein) of the width of the belt 200. A set of deflectors, scoops or collectors may deflect the seaweed towards the conveyor. Alternatively, one or more persons on the platform 140 may manually move the seaweed from open water towards the conveyor 130 until the bars or ridges 202 can bring the seaweed onto the platform 140. In one embodiment, the roller 132a is driven rotationally by a motor (not shown), causing the teeth 214a on the roller 132a to engage with the teeth 204 on the belt 200. In turn (e.g., simultaneously), the teeth 204 on the belt 200 engage with the teeth 214b on the free-rolling roller 132b. Typically, the motor-driven roller is out of the water 105. Alternatively, the roller 132b may also be rotationally driven by a motor identical to that driving the roller 132a, and troughs or grooves complementary to (e.g., configured to receive) the teeth 214a-b may be in the inner surface of the belt 200. The belt may comprise a rubber sheet or loop (which may be reinforced with wires or cords), linked chains (e.g., chain mail) or a metal mesh, etc. In some embodiments, the system 100 (e.g., one or more of the rollers 132a-b) may include a vibrating mechanism to facilitate the removal or escape of crabs, snails, mussels, etc. that may be in the seaweed. One or more persons on the platform 140 may manually move the seaweed to the second conveyor 150, or a third conveyor (not shown) configured to receive the seaweed 120 from the first conveyor 130 and move it to the second conveyor 150 may be on the platform 140. Once the seaweed 120 is out of the water 105 and on the boat or ship 110, it may then be transported to and processed by a refinery or other processing plant, and optionally packaged and/or stored using the exemplary system for packaging and transporting seaweed or aquatic flora discussed herein.

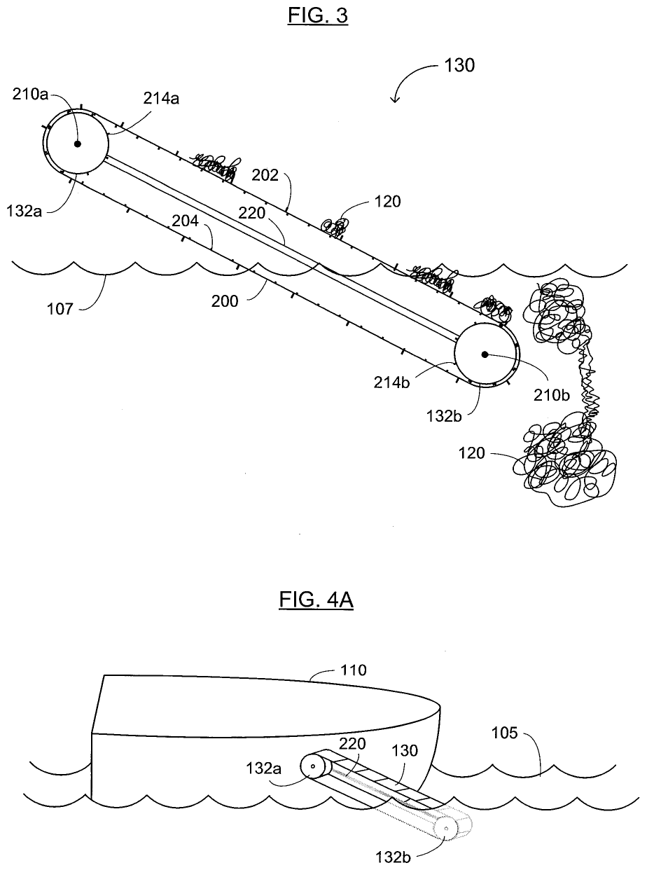

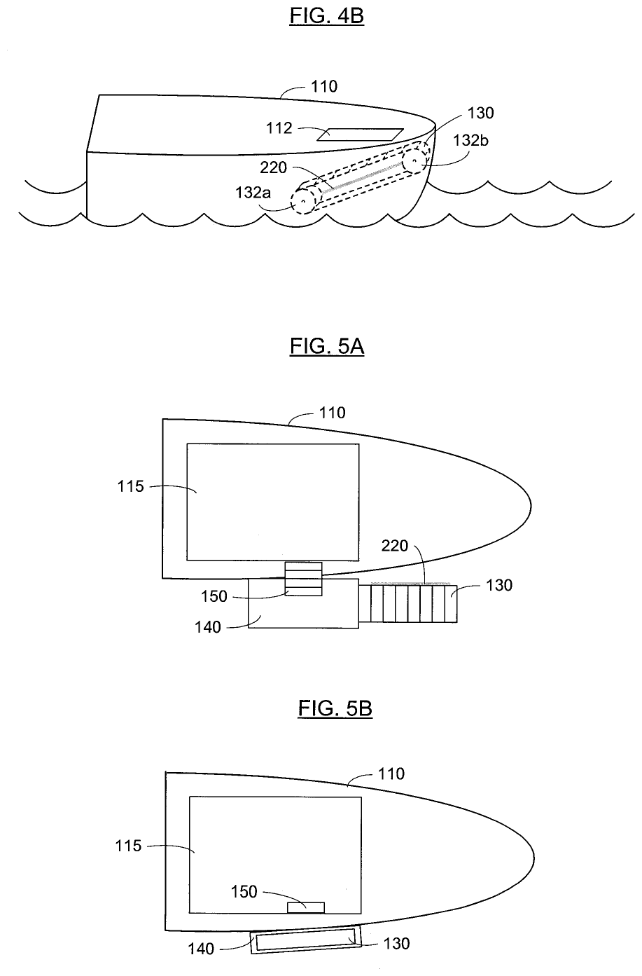

Thus, the present seaweed and aquatic plant harvesting and/or collecting system 100 benefits from a relatively small capital expense for the components of the system 100. In fact, existing capital assets can be repurposed for use in the present system 100. Production (i.e., the amount of seaweed harvested or collected per unit time) can be quickly scaled up using the present seaweed harvesting and/or collecting system 100. As a result, the present harvesting and/or collecting system 100 is not limited to harvesting or collecting wild seaweed or aquatic plants. Any seaweed/aquatic plant cultivation method that results in unsecured seaweed or plants in a body of water, not in or constrained by a net that can be raised by a boat or ship or similar collection device, can be collected using the harvesting and/or collecting system 100. In an alternate embodiment, the seaweed can be cut from a cultivation system and then collected using the present harvesting and/or collection method and apparatus. The simple design allows the present seaweed harvesting and/or collecting system 100 to be less vulnerable to malfunction and operational errors. The system 100 can be made resilient to the rigors of the marine environment (e.g., by water-proofing, preventing parts having different types of metal from touching, using sacrificial zinc anodes according to techniques known in the art, use of a polytetrafluoroethylene-containing anticorrosion agent or lubricant [e.g., TEF-GEL anticorrosion gel or lubricant] on all metal/metal contacts, use of stainless steel [especially 316 or 304 stainless steel] or titanium for exposed metal components such as beam 220, and/or integrating components of the system 100 with a storage-and-deployment mechanism; see, e.g., the discussions of FIGS. 4A-5B below). The present seaweed and aquatic plant harvesting and/or collecting system 100 may also be integrated with the present packaging, storage and/or transportation system disclosed herein.

FIGS. 4A-B show the exemplary conveyor 130 of FIG. 2 deployed (FIG. 4A) and stowed within the vessel 110 (FIG. 4B) according to embodiments of the invention. The conveyor 130 is deployed alongside the boat or ship 110, and the beam 220 is to the side of the conveyor 130, between the rollers 132a-b and the boat or ship 110. The beam 220 may be connected to a deployment mechanism (not shown) on or inside the boat or ship 110, comprising an extendable and/or rotatable shaft (not shown) which may have one or more adjustable and/or controllable joints or elbows therein). The extendable shaft may be or comprise a hydraulic cylinder, and the shaft or cylinder (or a section thereof defined at least in part by one or more of the adjustable and/or controllable joints or elbows) may be rotated using a motor (not shown) configured to rotate the shaft or section by 90-270°, for example. The deployment mechanism may comprise more than one such extendable and/or rotatable shaft.

FIG. 4B shows the conveyor 130 stored within the hull and below the deck of the boat or ship 110. The conveyor 130 may enter and exit the boat or ship 110 through a hinged or retractable port or opening 112. The opening 112 may have a length smaller than that of the conveyor 130, and the conveyor 130 may be rotated around an axis through the center or midpoint along the length of the beam 220 and orthogonal to the plane of the page to enter and exit through the opening 112. Alternatively, the conveyor 130 may be stored on or above the deck of the boat or ship 110.

FIGS. 5A-B show an exemplary seaweed and aquatic plant harvesting and/or collecting system deployed (FIG. 5A) and stowed within and alongside the vessel (FIG. 5B) according to alternative embodiments of the invention. In FIG. 5A, the system (i.e., the first conveyor 130, the platform 140, and the second conveyor 150) are deployed alongside the boat or ship 110 as shown in FIG. 1. In FIG. 5B, parts of the system that are used outside or alongside the boat or ship 110 (i.e., the first conveyor 130 and the platform 140) are stowed along the side of the boat or ship 110, and the second conveyor 150 is stowed in the cargo hold 115 of the boat or ship 110. In such embodiments, the platform 140 may be hingedly secured to the side of the vessel 110, and the vessel may have a mechanism (e.g., a motorized arm alongside the back end of the platform that rotates up or down to raise or lower the platform, or one or more wenches and one or more cables connecting the wench[es] to one or more far corners of the platform 140) for rotationally raising and lowering the platform 140.

In such embodiments, the platform 140 may have (1) a storage area below the surface for storing the first conveyor 130 and (2) an opening in the side facing the first conveyor 130 for the first conveyor 130 to enter and exit the storage area in the platform 140. The platform 140 may further include tracks in the storage area along which the first conveyor 130 may travel (e.g., using wheels attached to a frame that is, in turn, secured to the axle[s] of one or both rollers). Alternatively, the first conveyor 130 may be released from and retracted into the storage area using one or more (e.g., two) cables and/or chains secured to the first conveyor 130 (e.g., via an eyelet secured to an end of the axle extending beyond the sides of the roller 132a) and one or more winches configured to wind or release the cable(s) and/or chain(s).

The second conveyor 150 may be deployed from and retracted into the cargo hold 115 using one or more extendable and/or rotatable shafts, as described herein (e.g., one or more hydraulic cylinders in the cargo hold 115, which may have one or more controllably rotatable joints therein or thereon). Thus, the present seaweed harvesting and/or collecting system (i.e., the conveyors 130 and 150 and the platform 140) may be quickly and easily secured in advance of moving or foul weather.

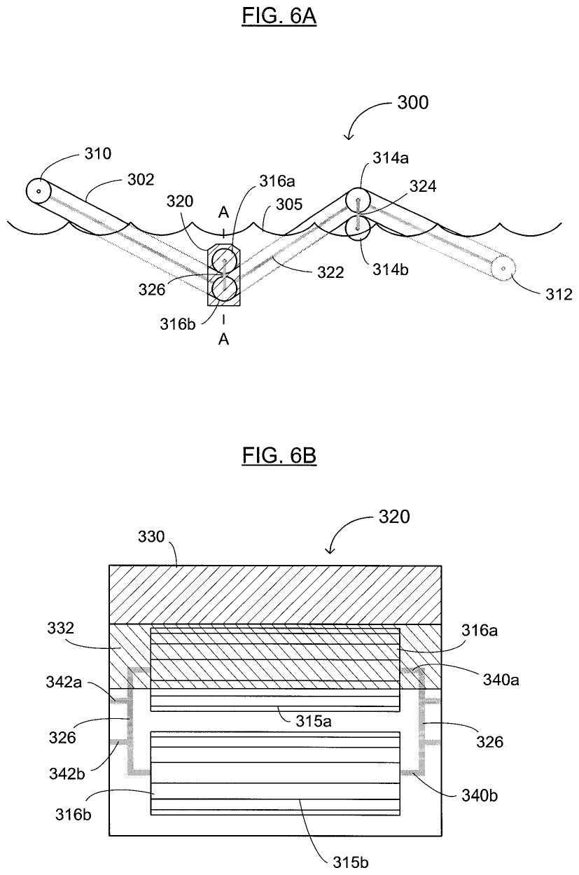

An alternate construction of the first conveyor is shown in FIG. 6A. FIG. 6A shows an exemplary conveyor 300 configured to immerse the seaweed (not shown) in the water 305 after initial collection. The conveyor 300 forces the seaweed under the water in the V-shaped section of the conveyor 300 above rollers 316a-b for a short duration, granting an opportunity for any disturbed (e.g., inadvertently collected) marine life to leave the seaweed before it is brought out of the water 305.

The conveyor 300 comprises three sections with alternating positive and negative angles (e.g., out of the water 305, then into the water 305, then back out of the water 305). The belt 302 (which may have ridges or bars on an outer surface thereof) pulls the seaweed out of the water 302 at roller 312. As the seaweed passes over roller 314, aquatic fauna may escape from the belt 302, but in some cases may be trapped in the seaweed. The conveyor 300 then takes the seaweed back into the water 305 as the belt 302 moves toward roller 316a, where trapped fauna may escape from the seaweed. Generally, the momentum of the seaweed entering the water 305 from the belt 302 and the boat or ship (not shown) moving forward enables most or all of the seaweed to be collected on the positive slope of the belt 302 between roller 316a and roller 310. When the seaweed passes over roller 310, it is deposited onto the platform (not shown), as described herein.

Rollers 316a-b separate the upper and lower sections of the belt 302, and are held in place relative to each other by a brace, beam or frame 326. Rollers 314a-b are similarly held in place relative to each other by a brace, beam or frame 324. Roller 314b is optional, but is useful for maintaining a desired tension on the belt 302.

FIG. 6B shows an exemplary roller shield 320 for the exemplary conveyor 300 of FIG. 6A, configured to prevent the seaweed or aquatic plant from being trapped between the rollers 316a-b and the conveyor belt 302 according to one or more embodiments of the invention. The belt 302 and the beam 322 spacing the rollers 314a and 316b from each other are omitted for clarity. The roller shield 320 comprises two side panels to the sides of the rollers 316a-b, a horizontal top panel (not shown), an angled top panel 330, and a front panel 332. The bottom of the front panel 332 is spaced sufficiently far away from the belt 302 that any bars or ridges on the belt 302 will not strike the front panel 332 under normal operating conditions, but close enough to make it very difficult for seaweed to pass through the opening between the front panel 332 and the belt 302. The top and front panels block the seaweed or aquatic plant from getting between the roller 316a and the belt 302, and more specifically between the teeth or bars 315a on the roller 316a and the belt 302.

The roller shield 320 is secured to the brace, beam or frame 326 by connectors 342a-b, which may be welded or bolted to both the brace, beam or frame 326 and the roller shield 320. Alternatively, the connectors 342a-b may be formed integrally with the brace, beam or frame 326, or secured to the brace, beam or frame 326 (and the roller shield 320) using fittings. In a further alternative, the connectors 342a-b are absent, and the brace, beam or frame 326 may be secured (e.g., by welding or bolting) directly to the roller shield 320.

### An Exemplary Seaweed Aquatic Flora Packaging and Transportation System

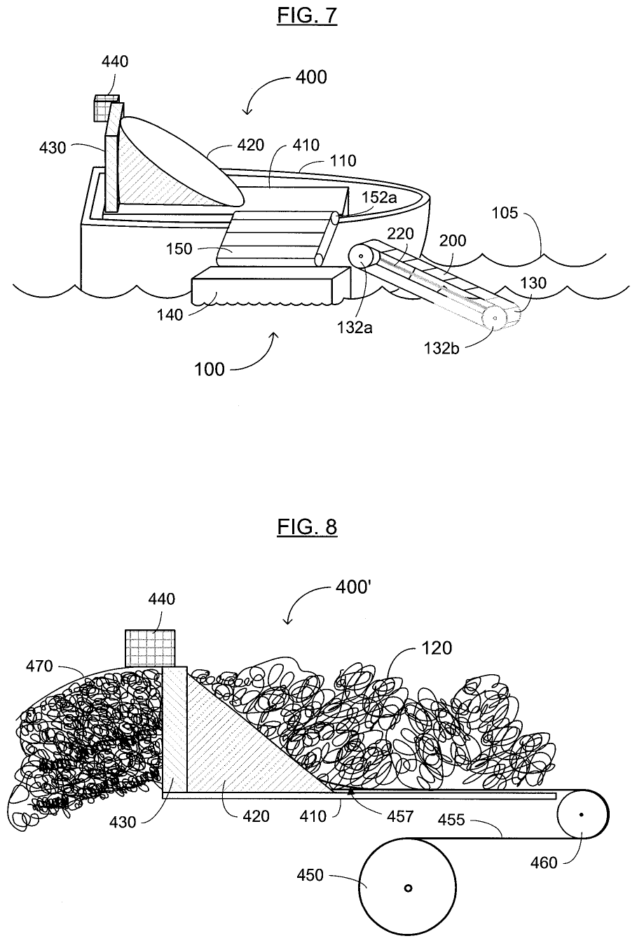

FIG. 7 shows an exemplary packaging system 400 configured to package seaweed or other floating sea flora, deployed on a boat or ship 110 and in use with the system 100 of FIG. 1. The present seaweed/aquatic plant packaging system 400 may comprise a processing surface 410 (such as a table or platform, which may be fitted with a conventional press [not shown] for squeezing liquid from plant, fruit or vegetable matter), a curved ramp 420, a compressor 430 and a sealer or stitching machine 440. For example, the processing surface 410 is generally flat and horizontal, and may have length and width dimensions that are an appreciable percentage (e.g., 20-80%, or any percentage or range of percentages therein) of the length and width of the vessel 110.

The curved ramp 420 (not drawn to scale) is configured to bring opposite edges of a sheet of an organic polymer such as polyethylene (PE) or similar waterproof or other water-resistant, sealable, lightweight material around a mass of material in the center of the sheet to form a sealable cylinder or similarly-shaped object. In addition to organic polymers, the packaging material may comprise a fabric (such as a woven polyester or nylon or cotton) or a paper, coated or impregnated with an organic polymer. The curved ramp 420 may comprise a metal, a ceramic and/or heavy-duty organic polymer (e.g., PE, polypropylene [PP], nylon or a blend thereof), and may have an inclined cropped cylinder or cylindrical wedge shape.

The compressor 430 is configured to force the seaweed on the sheet through an opening in a center area thereof. The compressor 430 may be further configured to clamp and seal upper and lower portions of the material together. The upper portion(s) of the material are brought over the lower portion of the material by the ramp 420. When there is no seaweed on the sheet, and the sheet comprises a thermally deformable material such as PE or PP, the clamp and fastening or sealing mechanism (which may comprise a heating press) can seal the material cross-wise and form an end of a link or other packaging unit. Alternatively, the compressor 430 may seal the sheet circumferentially, similarly to a large-scale tube sealer.

The fastener or stitching machine 440 is configured to close the opposite edges of the material brought together by the ramp 420. The fastener or stitching machine 440 may thus stitch the opposite edges of the material together, or may thermally compress the edges of the material together. In one embodiment, optionally biodegradable shrink wrap may be an acceptable packaging material, and the wrapping mechanism (e.g., ramp 420) and fastener (compressor 430 and/or fastener or stitching machine 440) secure the shrink wrap around the seaweed or aquatic plants. Thus, the fastening and/or securing mechanism may comprise a shrink wrap machine or other machine that ties or wraps a polymeric one-dimensional manifold or two-dimensional manifold or other binding material around the seaweed or aquatic plants. For example, biodegradable shrink wrap is known in the field, and can be found, for example, as biolefin at https://www.reefrepair.com/education/environment/biolefin/. A variety of shrink wrap machines are available to wrap the biomass and make it waterproof and airtight. For example, John Deere offers several balers and wrapping machines that wrap and/or shrink wrap biomass to make it airtight and watertight. See, for example, https://youtu.be/vYTcWhOmER4. Long tubes can be formed using similar devices that shrink wrap biomass and form long tubes of biomass that are airtight and watertight. See for example, https://youtu.be/GsXuZg8TG6Y brtps.//youtu.be/MRMoio5qaXjc. Such long bales are suitably hydrodynamic to be towed behind a ship or boat (e.g, a small fishing vessel) efficiently.

Referring back to FIGS. 1-2, as the vessel 110 moves slowly through water 105 (e.g., the tide of Sargassum 120), the first conveyor 130 in the exemplary system for harvesting seaweed 100 brings the seaweed 120 out of the water 105 and deposits it on the platform 140. This process of lifting the seaweed out of the water effectively dewaters the seaweed and leaves the seaweed as fresh seaweed, surrounded by air. It is much lighter, commonly 90% lighter by volume than when the interstitial spaces on or in the seaweed are filled with or surrounded by water, rather than air. One or more persons on the platform 140 may manually move the seaweed to the second conveyor 150, or a third conveyor (not shown) configured to receive the seaweed 120 from the first conveyor 130 and move it to the second conveyor 150 may be on the platform 140. The second conveyor 150 deposits the seaweed 120 onto a sheet of PE (not shown), another organic polymer, or another material on the processing surface 410.

Personnel on the vessel 110 may move the seaweed 120 into the center (length-wise) of the sheet, or automated arms (not shown) on the deck of the vessel 110 may do so. The sheet may be fed through the compressor 430 by one or more motorized rollers therein (e.g., after feeding an end of the sheet through the compressor 430 and sealing the end of the sheet). The compressor 430 may also contain one or more non-motorized rollers therein. In a further alternative, the sheet may be fed through the compressor 430 by gravity (e.g., after packaging of the seaweed has been initiated, and packaged seaweed remains connected to the sheet being fed through the compressor 430), which may also provide a compressive force for use by the compressor 430. The sealer or stitching machine 440 seals or stitches the edges of material together to form a tube or roll of packaged seaweed. After a predetermined length of packaged seaweed is formed (e.g., 10-200 m in length, and 5-50 m in diameter), the compressor 430 seals the sheet cross-wise to form a packaged unit.

The present seaweed/aquatic plant packaging system 400 is also useful independently from the harvesting and/or collecting system 100. The seaweed/aquatic plant packaging system 400 is a cost-effective mechanism for collecting, packaging and optionally transporting Sargassum and other, similar buoyant marine products than is placing it on a barge or in a boat, and regardless of how the seaweed/aquatic plant is harvested.

FIG. 8 shows an exemplary system 400′ for packaging seaweed 120 or other seaweed and aquatic plants in greater detail. The system 400′ may be configured to form relatively long, linear packages of seaweed 120 or other aquatic flora, similar to sausages. In addition to the platform/working surface 410, the closing ramp 420, the compressor or compression ring 430 and the sealer or stitching machine 440, the exemplary system 400′ may include a PE sheet on a roll 450 and a second roller 460. The PE roll 450 may be stored on deck (e.g., below the platform 410) or below deck (in which case the PE sheet may be brought through a slit or opening through the deck). The second roller 460 may be motorized to drive feeding of the PE sheet onto the platform 410. Alternatively, the second roller 460 may be free-rolling.

Optionally, the system 400 of FIG. 7 or the system 400′ of FIG. 8 may further comprise a compression piston on a wheel (not shown) to force the seaweed through the compressor or compression ring 430. Alternatively, in addition to gravity, the amount of compression at the compressor 430 may be augmented by compression added by the stitching machine or sealer 440.

An exemplary method of forming a linear packaged seaweed or aquatic plant unit may be described with reference to FIG. 8. First, a large roll 450 of material (e.g., a rolled polyethylene sheet) having a thickness of from 5-100 mils (e.g., 10 mils for PE), a width of 5-50 meters (e.g., 15-20 m for PE) and a length of 100-1000 meters (e.g., about 300 m for PE) is unrolled, fed around the second roller 460, and laid on the platform 410 until a predetermined length (e.g., about 10-15 m) of the sheet 455 is on the platform 410. The free end (along the width) of the sheet is folded (e.g., in half) and sewn or thermally compressed together to seal the free end of the sheet. An amount of seaweed 120 (e.g., Sargassum) or other aquatic flora is placed on the exposed/open section of the sheet (e.g., along the first 3-5 m of the sheet), starting from the sewn, fastened or sealed end and extending along the first/next 3-10 m of the sheet. The sheet is then fed through the closing ramp 420 and into the compressor 430. As the sheet 455 goes through the closing ramp 420, edges 457 of the sheet 455 may raise above the platform 410 in front of the closing ramp 420.

Along the section of the sheet 455 occupied by the seaweed 120, the compressor 430 forces the seaweed 120 through an opening in the compressor 430. The two free edges 457 of the sheet 455 brought together (and preferably overlapping) by the closing ramp 420 are sewn together, starting from the seam created in the compressor 430 and extending along the section of the sheet 455 occupied by the seaweed 120. At this point, a linear cylinder or tube 470 of seaweed, encased in the fastened, sealed or stitched sheet, is forming at the back of the system 400.

Continuously, sections of the sheet 455 are unrolled (e.g., 3-5 meters at a time) by moving the cylinder or tube 470 and/or advancing the sheet 455, and additional seaweed 120 is placed on the sheet 455. The additional sections of seaweed 120 encased in the sheet 455 are compressed in the compressor 430 and stitched, fastened or sealed together by the sealer or stitching machine 440 to extend the cylinder or tube 470.

This process is repeated until either the seaweed 120 is depleted, or the sheeting material 455 runs out. If the seaweed 120 is depleted, the sheet 455 may be cut width-wise and sealed to form the final cylinder or tube 470. The process may also be terminated arbitrarily or at a predetermined time (e.g., when the cylinder or tube 470 reaches a predetermined length, a work shift ends, a malfunction occurs, etc.). At termination, similarly to the cross-wise stitch or seal created at the beginning of the process, the final cross-wise/folded edge of the sheet is sewn or sealed to form the final cylinder or tube 470.

The final cylinder or tube 470 of seaweed 120 may be placed in the water without fear of or concern for sinking, as the density of most seaweed (such as Sargassum) and aquatic plants is less (e.g., roughly 20-80% less) than that of sea water, and without fear of or concern for dispersal. The final cylinder or tube 470 of seaweed 120 may then be towed a long distance (e.g., up to 2000-3000 km) with little hydrodynamic drag, and without needing to store the seaweed 120 in a large cargo vessel.

Alternatively, the seaweed or aquatic plants may be bound with a mesh or net made of one or more biodegradable materials (e.g., cotton, hemp, one or more cellulosic fibers, etc.). Although the seaweed or aquatic plants bound or packaged in such a manner may not float, it can be towed relatively easily. Such packaged seaweed or aquatic plants may be towed to nearby deep water (e.g., with a depth >1000 m), and sunk in the deep water as a form of carbon sequestration and/or carbon credits, as disclosed in U.S. Prov. Pat. Appl. No. 63/191,505, filed May 21, 2021 (Attorney Docket No. CF-016-PR), the relevant portions of which are incorporated herein by reference.

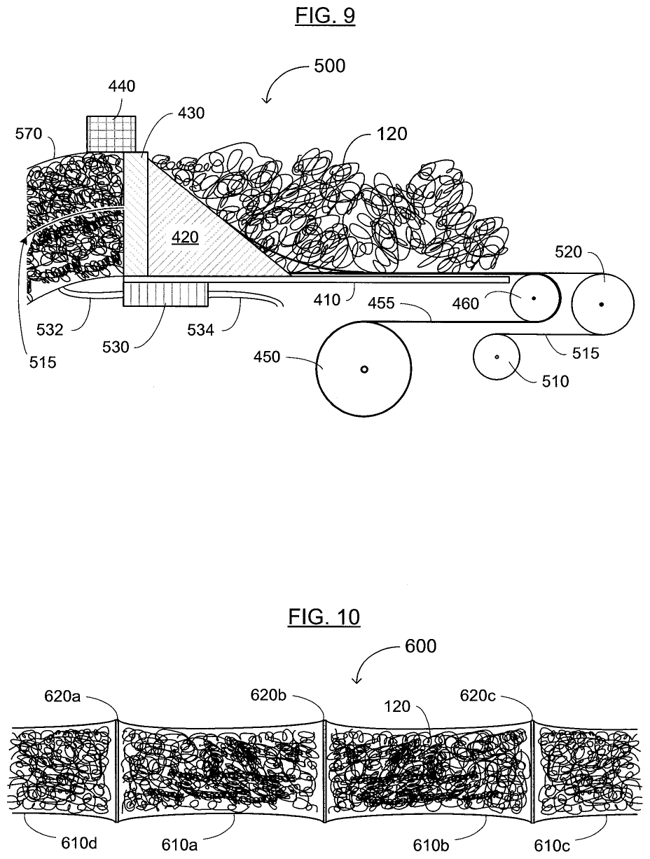

Referring back to FIG. 8, the final cylinder or tube 470 of seaweed 120 or aquatic plant(s) may be disconnected or cut from the compressor 430 and sealer or stitching machine 440, and connected or linked to the vessel 110 using a cable and a cable grip or trap (not shown). Alternatively or additionally, a steel (e.g., amsteel) line or cable can run through the cylinder or tube 470 of seaweed 120 (see FIG. 9 and the discussion thereof below), which can be then connected to the vessel 110 using any number of attachment mechanisms.

Thus, the present seaweed/aquatic plant packaging system 400/400′ benefits from a relatively small capital expense for the components. In fact, existing capital assets can be repurposed for use in the present system 100. Production (i.e., the amount of seaweed or aquatic plants packaged per unit time) can be quickly scaled up using the present seaweed/aquatic plant packaging system 400/400′. The design allows the present seaweed/aquatic plant packaging and transporting system 400/400′ to be less vulnerable to malfunction and operational errors. The system 400/400′ can be made resilient to the rigors of the marine environment (e.g., by water-proofing, preventing parts having different types of metal from touching, using sacrificial zinc anodes according to techniques known in the art, use of a polytetrafluoroethylene-containing anticorrosion agent or lubricant [e.g., TEF-GEL anticorrosion gel or lubricant] on all metal/metal contacts, use of stainless steel [especially 316 or 304 stainless steel] or titanium for exposed metal components, etc.).

The present seaweed and aquatic plant packaging system 400/400′ may also be integrated with the present seaweed/aquatic flora harvesting and/or collecting system 100 shown in FIGS. 1-2. Furthermore, in addition to Sargassum (e.g., Sargassum fusiforme), the exemplary packaging system 400/400′ can also be used to harvest or collect other seaweed, such as Eucheuma (e.g., Eucheuma cottonii or Eucheuma denticulatum, for production of carrageenan or food), Kappaphycus alvarezii, Gracilaria (particularly those species used for production of agar or ogonori), Saccharina (e.g., Saccharina latissima and Saccharina japonica), Undaria pinnatifida, Pyropia (particularly those species used for production of nori, Betaphycus gelatinae, Caulerpa lentillifera (e.g., for production of sea grapes), Chondrus crispus (Irish moss), and other kelp (e.g., of the orders Laminariales and Fucales, such as giant kelp [Macrocystis pyrifera] and giant brown kelp [Ecklonia maxima]), which along with certain Sargassum species, can be used as a food source, a source of raw material for value-added natural products, or a carbon sink for carbon credits (see, e.g., U.S. Provisional Pat. Appl. Nos. 63/191,798, and 63/191,505, both of which were filed on May 21, 2021 [Atty. Docket Nos. CF-014-PR and CF-016-PR], the relevant portions of each of which are incorporated herein by reference). Furthermore, the present packaging system 400/400′ can also be used to package seaweed or other macroalgae/aquatic flora grown on/in a platform/system for growing macroalgae and aquatic plants (see, e.g., U.S. Provisional Pat. Appl. No. 63/191,798, filed on May 21, 2021 [Atty. Docket No. CF-014-PR], the relevant portions of which are incorporated herein by reference). Also, prior to packaging, the seaweed or aquatic plant can be compressed to extract biomass therefrom. The biomass can be further processed (e g., extracted, filtered, purified, etc.) to obtain or recover valuable biological substances and/or materials.

FIG. 9 shows a modified version 500 of the seaweed/aquatic plant packaging system 400/400′ of FIGS. 7-8. The seaweed/aquatic plant packaging system 500 according to embodiments comprises the platform/working surface 410, the closing ramp 420, the compressor or compression ring 430, the sealer or stitching machine 440, the sheet of material on the roll 450, the second roller 460, a roll or spool 510 of metal wire or cable 515, a grooved roller or wheel 520, and a vacuum unit 530. Like the roll 450, the roll of metal wire or cable 510 may be stored on deck (e.g., below the platform 410) or below deck (in which case the wire or cable may be brought through an opening through the deck).

The metal wire or cable 515 (e.g., amsteel cable) may run or be fed through the center of the closed sheet 455 encasing the seaweed 120 (or other aquatic flora) so that the vessel may more easily or securely tow the cylinders or tubes 570 of seaweed 120. The wire or cable may be from 3 to 25 mm in diameter, or any diameter or range of diameters therein.

The groove in the roller or wheel 520 is configured to keep the wire or cable 515 in place as it is fed to the seaweed/aquatic plant packaging components of the system 500. The grooved roller or wheel 520 is configured to provide the wire or cable 515 to the center (width-wise) of the sheet 455, and may be motorized or free-rolling. An eyelet or other feeding/alignment mechanism in the closing ramp 420 or compressor 430 can feed the wire or cable 515 into the middle or center of the cylinder or tube 570 of seaweed 120.

The vacuum unit 530 may comprise a vacuum pump and a vacuum hose or tube 532. The vacuum hose or tube 532 may have a needle-like or other sharp end adapted to penetrate through the material 455. The vacuum unit 530 can then remove some or most of the air and optionally some of the liquid from the cylinder or tube 570 of seaweed 120. The tube 534, which is optional, may transport the air and liquid (if any) removed from the cylinder or tube 570 of seaweed 120 to a separate exhaust port and/or container configured to collect the liquid. In some embodiments in which the vacuum unit 530 removes some liquid from the cylinder or tube 570 of seaweed 120, the block 530 may be or comprise a trap configured to separate the liquid from the air. The separated air is then carried in the hose or tube 534 to the vacuum pump (not shown), which may be elsewhere on or below the deck of the vessel.

In various embodiments, the seaweed packaging system can form packaged seaweed/aquatic plant segments, one segment at a time. In such embodiments, the compressor 430 generally includes a clamping machine to form or create the joints between the segments. For example, FIG. 10 shows an exemplary packaged seaweed partial unit 600 in segments 610a-d, linked together through joints 620a-c. Thus, a singular cylinder or tube of seaweed 120 may be formed in a series of “links,” in which a predetermined length (e.g., 5-30 meters) of the material sheet or casing is pinched together (e.g., sealed by thermal compression and/or stitching) after passing through the compressor.

If a cylinder, tube or segment of seaweed/aquatic plant leaks or breaks, there is very little effect on the hydrodynamics of transporting the cylinder, tube or segment, as the seaweed/aquatic plant floats in the absence of the casing or material. The casing or material functions to keep the seaweed/aquatic plant together, rather than to keep it dry or to cause it to float. If the casing or material breaks, a small portion of the seaweed 120 may be lost. The damaged cylinder tube or segment can be repaired (e.g., by tying, stitching, closing or otherwise sealing off any opening in the cylinder, tube or segment) on each end, and use ropes to connect the two sides.

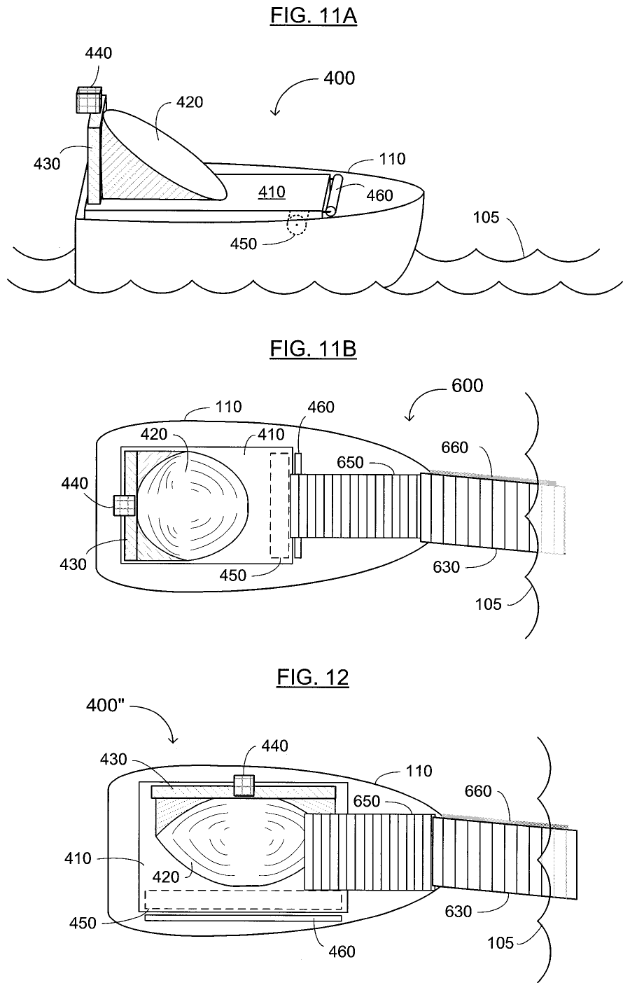

FIGS. 11A-B show perspective and top views, respectively, of the exemplary seaweed/aquatic plant packaging system 400 on a boat or other vessel 110. Although the system 400 and the vessel 110 are not drawn to scale in FIG. 11A, one can easily envision one or more systems 400 on a large cargo-type vessel 110 taking up half or more of the deck area and being able to package and process seaweed such as Sargassum and aquatic plants on a multi-kiloton scale.

FIG. 11B also shows the seaweed/aquatic plant packaging system 400 in use with an alternative seaweed/aquatic plant harvesting and/or collecting system 600 (a “front harvesting” system). The alternative seaweed/aquatic plant harvesting and/or collecting system 600 comprises first and second conveyors 630 and 650 and roller spacing beam 660. The first and second conveyors 630 and 650 are similar or identical to the first and second conveyors 130 and 150 in the harvesting and/or collecting system 100 (FIG. 1), and the spacing beam 660 is similar or identical to the beam 160 in the harvesting and/or collecting system 100. The forward part of the first conveyor 630 is below the water line 105. In embodiments of the front harvesting system 600, the platform (e.g., platform 140 in FIG. 1) is not necessary, as the first and second conveyors 630 and 650 are oriented in the same direction, and the first conveyor 630 can deposit the seaweed or aquatic plant(s) directly onto the second conveyor 650.

The second conveyor 650 deposits the seaweed or aquatic plant(s) (not shown for clarity) onto the sheet of material (not shown for clarity) on the processing surface 410. The curved ramp 420, compressor 430 and sealer or stitching machine 440 operate as described elsewhere herein. The cylinders, tubes or segments of packaged seaweed (also not shown) or aquatic plant(s) can be placed onto the water 105 directly from the compressor 430 and sealer or stitching machine 440 and towed behind the vessel 110.

An alternate construction 400″ of the seaweed/aquatic plant packaging system is shown in FIG. 12, along with the alternative seaweed/aquatic plant harvesting and/or collecting system 600 of FIG. 11B. In the seaweed/aquatic plant packaging system 400″, the unfolded sheet of material (e.g., PE) can be wider than the boat or ship 110. For example, the roll of material 450 can have an axis oriented along the length of the platform 410, and the sheet of material (not shown) can be unrolled from the roll 450 perpendicularly to the long axis of the vessel 110. Seaweed or other aquatic flora can be deposited onto the sheet towards the center of the sheet, and the closing ramp 420 (which may be more oval in shape/cross-section, and which is not shown to scale in FIG. 12) can still wrap the opposite edges of the sheet around the seaweed or aquatic plant(s) as it passes through the closing ramp 420 and the compressor 430. As the finished/packaged cylinders, tubes or segments of seaweed or aquatic plant(s) are placed on the water to the side of the vessel 110, they may be manually or automatedly moved behind the vessel 110 and towed in the same manner as described elsewhere herein. Space for additional cylinders, tubes or segments of seaweed or aquatic plant(s) is then available to the side of the vessel 110.

The total weight or volume of seaweed that the boat or ship 110 can transport depends on the size or engine power of the vessel (e.g., the boat or ship), among many other things. The seaweed/aquatic plant material is effectively being towed, rather than hauled (e.g., as cargo). Once the seaweed or aquatic plant(s) is encased in the material (e.g., polyethylene) and floating on the water, it becomes a vessel without an engine. The amount of packaged seaweed or aquatic plant(s) that can be transported then becomes a function of factors such as the strength of the material sheeting, the rope or cable running through the cylinders, tubes or segments of seaweed, and/or power of the engine of the vessel 110.

The seaweed/aquatic plant packaging system may also have an on-board dehydrator to dry the seaweed or aquatic plant(s) prior to or during packaging. The addition of a dehydrator is not only feasible, it is arguably encouraged (e.g., as part of an on-board processing facility). For example, liquid may be extracted from the seaweed (e.g., for use as or conversion into biostimulant) or other aquatic flora on the boat 110, and the extraneous biomass can be packaged and brought to shore for conversion into biofuel (e.g., ethanol), or it could be disposed overboard to sink and sequester carbon (see, e.g., U.S. Prov. Pat. Appl. No. 63/191,505, filed May 21, 2021 [Attorney Docket No. CF-016-PR], the relevant portions of which are incorporated herein by reference). In the latter case, the material may be heavier than water or porous to water to facilitate the ability to sink the processed seaweed or aquatic plant(s). In some embodiments, the material may comprise or consist essentially of a biodegradable material, such as poly(γ-hydroxybutyric acid), modified cellulose and cellulose blends, etc.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by any claims of any subsequent nonprovisional application claiming priority to this application and their equivalents.

1. A system for packaging seaweed and/or aquatic plants, comprising:
a wrapping mechanism configured to wrap the seaweed or aquatic plants in a watertight lightweight material,
a fastening and/or sealing mechanism configured to attach the lightweight material around the seaweed or aquatic plants therein, and
a unitizer or link former configured to form fastened units from the lightweight material with the seaweed or aquatic plants therein.

2. The system of claim 1, further comprising one or more rollers, at least one of which has the lightweight material in a roll thereon.

3. The system of claim 1, wherein the lightweight material comprises an organic polymer.

4. The system of claim 1, wherein the wrapping mechanism comprises a material closing ramp, and the system further comprises a compression ring.

5. The system of claim 1, wherein the fastened units comprise pods, casings, packets, parcels or links.

6. The system of claim 1, further comprising a system for harvesting and/or collecting the seaweed and/or aquatic plants that comprises:
a platform,
a first conveyor configured to collect the seaweed or aquatic plant from a body of water and transport the seaweed or aquatic plant to the platform, and
a second conveyor configured to transport the seaweed or aquatic plant from the platform to a deck of an aquatic vessel.

7. An aquatic vessel, having a deck and further comprising the system of claim 1 on and optionally at least partially below the deck, wherein the system is configured to process the seaweed and/or aquatic plants, and the aquatic vessel is configured to transport the fastened units.

8. The aquatic vessel of claim 7, comprising a ship or a boat.

9. A method of packaging seaweed and/or aquatic plants, comprising:
placing or depositing the seaweed or the aquatic plant(s) adjacent to a two-dimensional manifold of a lightweight material,
wrapping the seaweed or the aquatic plant(s) in the lightweight material, and
fastening the lightweight material to form a water holding packaged unit or link in which the seaweed or aquatic plant(s) is fastened, secured or otherwise contained in the lightweight material.

10. The method of claim 9, wherein the lightweight material comprises an organic polymer.

11. The method of claim 9, wherein sealing the lightweight material may comprise stitching one or more edges of the lightweight material to an opposite edge or other part of the lightweight material, and compressing or stitching the lightweight material cross-wise.

12. The method of claim 9, further comprising repeating the method to form a series of linked packaged units of seaweed or aquatic plant(s).

13. The method of claim 9, further comprising transporting the seaweed or aquatic plant(s) on a body of water using an aquatic vessel.

14. The method of claim 13, wherein the aquatic vessel is a ship or boat, and the body of water is a lake, bay, inlet, river, gulf, sea or ocean.

15. The method of claim 9, wherein the seaweed or aquatic plant(s) is/are placed or deposited in a sleeve or cylinder of the lightweight material, and sealing the lightweight material comprises compressing or stitching the lightweight material cross-wise to form the packaged unit or link.

16. The method of claim 9, further comprising
collecting the seaweed or aquatic plant(s) from the body of water,
transporting the seaweed or aquatic plant(s) to a platform using a first conveyor, and
transporting the seaweed or aquatic plant(s) from the platform to a deck of a vessel using a second conveyor.

17. Packaged seaweed and/or aquatic plant(s), comprising:
a lightweight material, folded onto itself and fastened, sealed and/or stitched at a plurality of borders thereof, and
the seaweed or aquatic plant(s) in the lightweight material.

18. The packaged seaweed and/or aquatic plant(s) of claim 17, containing at least 150 kg of the seaweed or aquatic plant(s).

19. A plurality of the packaged seaweed and/or aquatic plant(s) of claim 17, linked together in a series.
